(19) United States
(12) Patent Application Publication
(10) Pub. No.: US 2020/0012517 A1
(43) Pub. Date: Jan. 9, 2020

(54) COMPUTER SYSTEM INFRASTRUCTURE AND METHOD OF HOSTING AN APPLICATION SOFTWARE

(71) Applicant: Fujitsu Technology Solutions Intellectual Property GmbH, München (DE)

(72) Inventors: Timo Bruderek, München (DE); Jürgen Atzkern, München (DE)

(21) Appl. No.: 16/506,096

(22) Filed: Jul. 9, 2019

(30) Foreign Application Priority Data
Jul. 9, 2018 (DE) 10 2018 116 554.4

(51) Int. Cl. G06F 9/48; G06F 9/455

(52) U.S. Cl. CPC G06F 9/4856; G06F 9/45558; G06F 2009/45595; G06F 2009/4557; G06F 9/45537

(57) ABSTRACT

A computer system infrastructure includes at least one edge computer system and at least one cloud computer system, wherein the edge computer system is connectable to the cloud computer system, both in the edge computer system and in the cloud computer system a virtual environment for hosting an application software is configured, respectively, the virtual environment of the edge computer system and the virtual environment of the cloud computer system are configured as unified host environments for the application software, respectively, the application software is provided within one of the virtual environments of the edge computer system and the cloud computer system, and the edge computer system and the cloud computer system are configured to transfer the application software between the two virtual environments of the edge computer system and the cloud computer system.

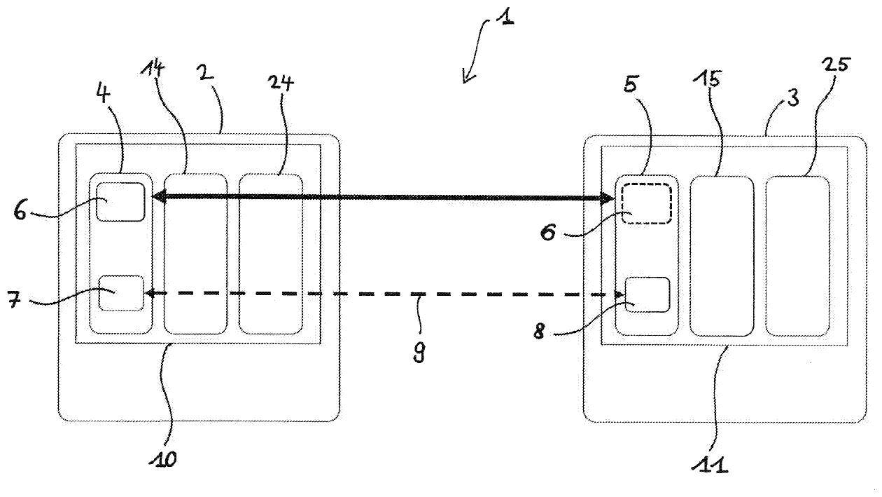

### TECHNICAL FIELD

This disclosure relates to a computer system infrastructure comprising at least one edge computer system and at least one cloud computer system, wherein the edge computer system may be connected to the cloud computer system. This disclosure also relates to a method of hosting an application software in such a computer system infrastructure.

### BACKGROUND

In computer system infrastructures including a plurality of computer systems, it becomes more and more important to transfer application software that provides dedicated services or applications between the computer systems depending on the resources. In particular, in computer system infrastructures comprising a so-called edge computer system on the one side and a cloud computer system on the other side (for example, within a data center), a transfer of application software from the cloud to the edge (or vice versa) is often desired to achieve high performance and usability of services or applications and/or to meet real-time requirements. There is often an issue in such computer system infrastructures that the hardware or the hardware environment of the edge computer system side is not comparable to the hardware or hardware environment on the cloud computer system side and may sometimes differ completely. In addition, in such computer system infrastructures there are issues regarding latency and low bandwidth in a data connection, which in addition may only be setup temporarily, as required, to temporarily connect an edge computer system to the cloud computer system. In this respect, a flexible transfer of dedicated services or applications between such kind of computer systems is often not easily performed.

Often, application programs or application software, which are to be transferred between computer systems in a computer system infrastructure, are encapsulated in defined software containers. The functionality and components of application software may be easily combined and transferred as one or more container files between the computer systems. However, such container solutions require identical operating environments, wherein the respective containers may be operated, in any associated computer systems. In addition, in such kind of solutions a management instance is required which checks in which operating environment and on which computer system an application program is executed at a determined time to ensure that the application program is executed on only one computer system and not on a plurality of computer systems of the infrastructure at the same time, which would waste resources.

To transfer container files within clusters of a plurality of computer systems there are already common orchestration solutions available as, for example, the framework “Kubernetes.” However, such kinds of frameworks are exclusively provided and feasible for use within cloud environments, that is within data centers, for example. However, for computer system infrastructures of the kind described above, including a collaboration between different edge computer systems and cloud computer systems, such solutions do not work.

It could thus be helpful to implement a computer system infrastructure and a method of hosting an application software which enable a more dynamic, more flexible and easier hosting of an application software within such a computer system infrastructure.

### SUMMARY

We provide a computer system infrastructure including at least one edge computer system and at least one cloud computer system, wherein the edge computer system is connectable to the cloud computer system, both in the edge computer system and in the cloud computer system a virtual environment for hosting an application software is configured, respectively, the virtual environment of the edge computer system and the virtual environment of the cloud computer system are configured as unified host environments for the application software, respectively, the application software is provided within one of the virtual environments of the edge computer system and the cloud computer system, and the edge computer system and the cloud computer system are configured to transfer the application software between the two virtual environments of the edge computer system and the cloud computer system.

We also provide a method of hosting an application software in a computer system infrastructure including at least one edge computer system and at least one cloud computer system, including at least temporarily connecting the edge computer system to the cloud computer system such that both the edge computer system and the cloud computer system each provide a virtual environment to host an application software, respectively, wherein the virtual environment of the edge computer system and the virtual environment of the cloud computer system are configured as unified host environments for the application software and the application software is provided within one of the virtual environments of the edge computer system and the cloud computer system, and, when a predetermined resource event occurs, is transferred to the other of the virtual environments of the edge computer system and the cloud computer system.

### BRIEF DESCRIPTION OF THE DRAWINGS

The Drawing shows a schematic depiction of our computer system infrastructure.

### LIST OF REFERENCE NUMBERS

1 Computer system infrastructure
2 Edge computer system
3 Cloud computer system
4 Virtual environment
5 Virtual environment
6 Application software
7 Resource control component
8 Resource control component
9 Communication link
10 Hypervisor
11 Hypervisor
14 Virtual environment
15 Virtual environment
24 Virtual environment
25 Virtual environment

### DETAILED DESCRIPTION

Our computer system infrastructure comprises at least one edge computer system and at least one cloud computer system. The edge computer system may connect to the cloud computer system (at least transiently, that is temporarily). Both in the edge computer system and also in the cloud computer system a virtual environment for hosting an application software is configured, respectively. The virtual environment of the edge computer system and the virtual environment of the cloud computer system are each configured as unified host environments for the application software. The application software is provided within one of the virtual environments of the edge computer system and the cloud computer system. The edge computer system and the cloud computer system are configured to transfer the application software between the two virtual environments of the edge computer system and the cloud computer system. A respective transfer may be controlled by the edge computer system and/or by the cloud computer system.

Such a computer system infrastructure including an edge computer system and a cloud computer system is advantageous compared to traditional infrastructures of this kind in that an application software may be transferred between the network edge and the cloud in a flexible and dynamic way depending on the specific use and use scenario, although there are completely different hardware environments on the network edge side and on the cloud side in the associated edge computer systems and the associated cloud computer systems. Thus, it is not required to adapt the application software to the different hardware environments by using different interfaces, program versions, program configurations and the like, and it is also not required to be configured in different program versions for the respective hardware environments. Rather, the application software may be configured in a unified way, and may be operated both in the edge environment and in the cloud environment in a straightforward way. Hereto, a virtual environment for hosting the application software is both configured on the edge computer system side and on the cloud computer system side of the computer system infrastructure described, respectively. Both virtual environments are thus configured as unified host environments for hosting application software. This means that both the virtual environment of the edge computer system and the virtual environment of the cloud computer system provide a unified ecosystem including unified or identical configurations and interfaces for the application software. In particular, the virtual environments of both computer systems provide virtual interfaces to the application software so that the application software may be operated within both virtual environments in a unified way. Both of the virtual environment of the edge computer system and the virtual environment of the cloud computer system may be specifically configured for hosting the application software. Due to the unified host environments provided both in the edge computer system and in the cloud computer system by the respective virtual environments, the application software may be transferred to the respective computer system as an appropriate resource without any required substantial modifications or adaptions, and may directly be provided thereto.

By the two virtual environments, a connection of the application software by a control mechanism of the respective virtual environments is provided to the hardware level of the associated computer systems. Such a control mechanism may be performed by a respective hypervisor or VM monitor, for example, configured in the edge computer system and in the cloud computer system, respectively. This way, a transfer and variable hosting of application software within the computer system infrastructure including at least one edge computer system and at least one cloud computer system may be easily performed, although there are completely different hardware environments in the edge computer system and the cloud computer system. The computer system infrastructure of the kind described above thus enables a straightforward transfer of particular services or applications depending on the use case either to the cloud environment or to the edge environment.

In that context, the term “edge computer system” shall denote a system configured on or in the machines, plants, or components to be monitored to monitor, control and/or sense machines, plants, or components. In particular, the edge computer system may be configured in a dedicated way for the use at operating sites having an exposed location and/or operating sites having severe environmental impacts. The edge computer system may in particular be configured with a desired performance for collecting data and/or controlling the machine, plant, or component to be monitored in real time.

In this context, the term “cloud computer system” shall denote a system for background processing or provision of data exchanged between the edge environment or the user terminal environment, respectively, and the cloud. The cloud computer system may, for example, be configured as a high performance system (for example, as a server) within a data center of a provider. Therefore, the cloud computer system may be completely decoupled from the edge computer system in terms of location and/or logics. The edge computer system may (temporarily) connect to the cloud computer system by a data connection.

In various examples of the computer system infrastructure a first resource control component that determines resource information of the edge computer system is configured in the edge computer system. Alternatively or complementarily, in the cloud computer system, a second resource control component may be configured to determine resource information of the cloud computer system. The edge computer system and the cloud computer system may be configured such that the application software is transferred between the edge computer system and the cloud computer system depending on the resource information determined by the first and/or the second resource control component.

By the (first or second) resource control component configured in the edge computer system and/or in the cloud computer system, resource information may be determined that allows for identification of the resource distribution, performance, error states, or operating states of the edge computer system and/or the cloud computer system. By such determined resource information, the computer system infrastructure thus allows a transfer depending thereof of the application software between the edge computer system and the cloud computer system. The respective resource control component configured in the edge computer system and/or cloud computer system thus enables to dynamically determine resource information to decide a dynamic transfer of the application software to that computer system, which is the best resource for operating the application software in a particular use case.

The resource control component of the respective computer system is, for example, implemented in the respective virtual environment. This offers the advantage that by the respective resource control component the host environment for the application software may be directly monitored regarding the performance thereof or resource characteristics thereof. Alternatively, the respective resource control component may also be implemented in a higher-level module of the respective virtual environment, in a hypervisor or a host operating system of the respective computer system that manages the virtual environment, for example. This offers the advantage that the resource control component may monitor the components of the respective computer system that manage or control the virtual environment. It is also possible that the resource control component also requires hardware parameters of the respective computer system to derive corresponding resource information thereof. As an alternative, it is possible to configure respective resource control components to determine resource information both in the virtual environment and in the higher-level components of the virtual environment in the respective computer system. Any resource control components may be part of a dynamic resource control system.

In various examples and configurations of the computer system infrastructure, in the edge computer system and/or in the cloud computer system a resource decision logic is implemented to decide, whether a transfer of the application software between the edge computer system and the cloud computer system has to be performed depending on the resource information determined by the first and/or second resource control component. Such a resource decision logic offers the advantage that by the resource information determined by the resource control components, a dynamic resource distribution may be performed between the edge computer system and the cloud computer system. Depending on the specific use, either the edge computer system or the cloud computer system may be selected as a resource to provide a service specified by the application software.

Depending on whether the resource decision logic(s) determines the edge computer system or the cloud computer system as resource for the application software, the application software may be transferred to the determined computer system, if the application software is not yet executed on the computer system. Thus, in the computer system infrastructure no further dedicated management component is required in addition to the edge computer system and the cloud computer system as, for example, a master system to perform an intelligent resource distribution such as a transfer of an application software between the edge computer system and the cloud computer system. Therefore, the computer system infrastructure is also easy to implement regarding this aspect. Any resource decision logics may be part of a dynamic resource control system.

Also, in this context, a decisive effect of the computer system infrastructure described above becomes evident, under the control of the resource decision logic(s) the application software may be operated both in the edge computer system and also in the cloud computer system in a unified host environment, and from a perspective of the application software it does not matter, on which computer system it is provided and executed. A communication between the application software and the different hardware environments of the edge computer system and the cloud computer system is performed by the respective virtual environments as described above.

A respective resource decision logic may be implemented in a way that it is not only deciding about the transfer of the application software to the appropriate computer system, but also ensures that the application software is executed only one time on a dedicated computer system within the computer system infrastructure. This way, the resource decision logic enables not only distribution of resources in the best possible way, but also to leverage resources in the best possible way. The respective resource decision logic may further be implemented in a way that the determined resource information may be evaluated by a predetermined metrics for a decision of the transfer of the application software between the corresponding computer systems. Such a metric may, for example, comprise predefined rules of a resource distribution between the associated computer systems, depending on predetermined application scenarios, if appropriate. This way, the computer system infrastructure may be selectively adapted to different use scenarios, wherein the application software is provided once in the edge computer system and once in the cloud computer system. A provision in the edge computer system may, for example, be directly used for data collection in the edge environment, while a provision in the cloud computer system may be used for data processing in the cloud.

In different examples/configurations of the computer system infrastructure, the first resource control component and the second resource control component are configured to communicate with each other and exchange determined resource information. A respective communication may, for example, be performed by a message based machine-to-machine protocol, for example, MQTT (Message Queue Telemetry Transport). Also regarding hereto, the edge computer system and the cloud computer system may exchange information with each other and may cause a respective transfer of the application software to the preferred computer system without any higher-level master system being required. If a communication is implemented by MQTT, only a so-called MQTT broker is required, which receives the respective messages of the edge computer system or the cloud computer system and forwards them to the respective other system. It is possible that such a MQTT broker is configured within the cloud environment of the cloud computer system.

In various examples/configurations, the application software is configured as one or more container files. This way, the application software may be assembled and built in a flexible way and may be easily transferred as a “portable” application software between the associated computer systems. In addition, a management of the application software regarding modifications, re-configurations, or updates may thus be easily performed. This may be performed by a packet distribution service, for example.

The method is used to host an application software in a computer system infrastructure comprising at least one edge computer system and at least one cloud computer system, wherein the edge computer system is at least temporarily connected to the cloud computer system. In the method, both the edge computer system and the cloud computer system provide a virtual environment that hosts an application software, respectively. The virtual environment of the edge computer system and the virtual environment of the cloud computer system are configured as unified host environments for the application software, respectively. In the method, the application software is provided within one of the virtual environments of the edge computer system and the cloud computer system and, when a predetermined resource event occurs, is transferred to the (respective) other of the virtual environments of the edge computer system and the cloud computer system.

Compared to conventional procedures, such a method has the advantage that an application software may be transferred in a flexible and easy way within a computer system infrastructure including completely different hardware environments of the associated computer systems in terms of a resource distribution depending on a particular application scenario. Regarding implementation of the application software and hosting the application software in a respective unified host environment for the application software both in the edge computer system and in the cloud computer system, the advantages already described above relating to a computer system infrastructure also apply. In particular, the application software may be provided by the respective virtual environments within the edge computer system and within the cloud computer system despite of completely different hardware environments in a unified, flexible, and easy way. As an occurrence of a predetermined resource event is monitored, the application software may be transferred between the associated computer systems so that the computer system, wherein the application software is executed, provides the application software as an excellent resource for a particular use. This way, predetermined services provided by the application software or applications may be used either in the edge environment next to the machine, plant, or component to be monitored, or alternatively in a cloud environment (as remote background environment).

The term “resource event” denotes a predetermined event that triggers and/or requires a redistribution of resources, in particular a transfer of application software within the computer system infrastructure. This may, for example, be any change in a load distribution, performance or operating behavior, fault behavior or the like between the edge computer system and the cloud computer system. Based on such a resource event, the method allows a dynamic decision of a transfer of the application software to that computer system within the computer system infrastructure which is the optimum resource for a particular use.

In various implementations of the method, resource information of the edge computer system is determined in the edge computer system. Alternatively or complementarily, resource information of the cloud computer system is determined in the cloud computer system. The determined resource information may be evaluated regarding the occurrence of a predetermined resource event. This way, the method allows for monitoring of an occurrence of a predetermined resource event based on the resource information determined in the edge computer system and/or in the cloud computer system without a higher-level master system being required. The resource information may be determined in the respective computer system by using a resource control component, for example. Evaluation of the determined resource information may be performed by such resource control components or alternatively by one or more resource decision logics. Reference is made to the description above regarding resource control components and/or resource decision logics regarding a computer system infrastructure.

In various examples of the method, the edge computer system and the cloud computer system exchange determined resource information by a message based machine-to-machine protocol. Such a protocol may be MQTT, for example. Hereto, reference is made to the description above regarding a computer system infrastructure.

In various examples of the method, the application software is provided as one or more container files. In this context, reference is made to the description above regarding a computer system infrastructure.

The shown examples, implementations and advantageous aspects of the computer system infrastructure of the kind described above may be realized in the respective implementations, methods and advantageous aspects of the method of the kind described above and vice versa.

In the following, our systems, infrastructure and methods are described in detail according to an example with reference to a Drawing.

The Drawing shows an example of a computer system infrastructure 1 including an edge computer system 2 and a cloud computer system 3 that may connect by a data connection at least temporarily so that the edge computer system 2 may connect to the cloud computer system 3. The edge computer system 2 is, for example, configured on or in a machine, plant, or component to be monitored, while the cloud computer system 3 is configured on a remote site, within a data center, for example. Data may be exchanged between the edge computer system 2 and the cloud computer system 3 using the at least temporary data connection.

According to the Drawing, the edge computer system 2 is configured with a plurality of virtual environments 4, 14, and 24 that provide predetermined virtualized functionality as virtual machines. According to the example of the Drawing, the virtual environments 4, 14, and 24 are controlled by a hypervisor or VM monitor 10 that performs communication between the virtual environments 4, 14, and 24 and a host operating system or hardware of the edge computer system 2.

Within the virtual environment 4 an application software 6 is installed, which is executed during operation of the edge computer system to provide a particular service and/or a particular application or functionality. By the application software 6, the edge computer system 2 is thus executing a particular function in the edge environment. This may, for example, be collecting and evaluating of sensor data regarding a machine, plant, or other component to be monitored by the edge computer system 2. The application software 6 is, for example, implemented as one or more container files, wherein predetermined application components, libraries, functions, operating system components or the like are embedded in one or more container files. This way, the application software 6 is operated within the virtual environment 4, which as a host environment hosts, manages and provides the application software 6.

In addition, a resource control component 7 is implemented in the virtual environment 4 that determines the resource information of the edge computer system 2. The resource control component 7 may be implemented in a way that it only determines performance or operating data within the virtual environment 4. Alternatively or complementarily, the resource control components 7 may also be implemented to determine performance and operating data of further components 14, 24, and 10 and other software and hardware components of the edge computer system 2. The resource control component 7 may further be implemented in a way serving only as an interface of a higher-level resource component (not shown), wherein the higher-level resource component determines information within the virtual environment 4 by the resource control component 7. A functionality of the resource control component 7 is described in the following in detail.

In the example according to the Drawing, the cloud computer system 3 also comprises three virtual environments 5, 15, and 25 that provide virtual functionalities within the cloud computer system 3. The virtual environments 5, 15, and 25 are monitored and controlled by a hypervisor and/or VM monitor 11. The descriptions made above regarding the virtual environments 4, 14, and 24 and the hypervisor 10 also apply in the same way.

Within the virtual environment 5, according to the Drawing, an additional resource control component 8 is configured. The functionality thereof may be implemented in the same way as for the resource control component 7 within the virtual environment 4 of the edge computer system number 2 so that the descriptions made above relating to the resource control component 7 also apply here in the same way.

The resource control component 7 within the edge computer system 2 and the resource control component 8 within the cloud computer system 3 may communicate at least temporarily via a communication link 9 and exchange determined resource information by the respective resource control components 7 and 8. The communication link 9 may, for example, be configured as MQTT connection (by an MQTT broker communicating between the edge computer system 2 and the cloud computer system 3, not shown, if required). A MQTT connection or a message-based machine-to-machine protocol in general offers the advantage compared to other communication protocols that the edge computer system 2 and the cloud computer systems 3 do not need any open network ports for the communication link which listen to the network traffic by using respective services to accept external attempts to establish a connection. To exchange messages, the edge computer system 2 and the cloud computer systems 3 retrieve the respective messages that have been stored for them within the MQTT broker by using port knocking or polling procedures. This way, both the edge computer system 2 and the cloud computer system 3 may be executed in a tamper-proof way. In addition, no “keep alive” connection to a higher-level master system is required for this kind of message-based communication between the two computer systems 2 and 3. In the topology according to the Drawing, such a master system is not required, and it is also not feasible due to a limited bandwidth or a temporary failure of a data connection between the edge computer system 2 and the cloud computer system 3. A resource distribution explained below is exclusively performed by an information exchange between the computer systems 2 and 3 by resource information determined by the resource control components 7 and 8.

By determining resource information by the resource control component 7 within the virtual environment 4 of the edge computer system 2, an occurrence of a predetermined resource event may be identified, for example. Such an identification may be performed by a resource decision logic (not shown) within the edge computer system 2, or by a respective resource decision logic (also not shown) implemented in the cloud computer system 3. In the latter, resource information determined by the resource control component 7, is transferred from the edge computer system 2 to the cloud computer system 3, by using the communication link 9, for example, and is evaluated there. The occurrence of a predetermined resource event may, for example, comprise a changed operating situation or a changed performance of the edge computer system 2 or a changed load of the computer systems 2 and 3 within the computer system infrastructure 1.

Based on the occurred resource event determined by the resource information of the resource control unit 7, a transfer of the application software 6 from the edge computer system 2 to the cloud computer systems 3 may be decided by the resource control components 7 and 8 or by using respective resource decision logics of the kind described above. Such a decision may be performed, for example, when a service provided by the application software 6 or a respective application is to be provided as functionality within the cloud computer system 3 instead of a functionality within the edge computer system 2. When a decision is made for a respective transfer of the application software 6, the application software 6 may thus be transferred from the edge computer system 2, more precisely from the virtual environment 4, to the cloud computer system 3, more precisely to the virtual environment 5 (see the arrow between the virtual environments for 5). The application software 6 is thus transferred by one or more container files from the virtual environment 4 of the edge computer system 2 to the virtual environment 5 of the cloud computer system 3. A respective transfer may be performed by one or more of the resource control components 7, 8, or by one or more resource decision logics which may be part of a dynamic resource control system. Also, a predetermined metrics may be used.

In the virtual environment 5, the applications software 6 may be finally provided directly after the transfer thereof (see the dashed marking of the application software 6 within the virtual environment 5). This way, as shown in the Drawing, a service provided by the application software 6 may be moved from the edge computer system 2 to the cloud computer systems 3 (or vice versa). For example, by the determined resource information, which is collected by using the resource control components 7 and/or 8, it may be decided that a data collection or evaluation by the application software 6 is performed within the cloud computer systems 3 instead of performing it within the edge computer system 2 (or vice versa).

From a perspective of the application software 6, the virtual environments 4 and 5 in the respective computer systems 2 and 3 each provide a unified host environment to operate the application software 6. That means, that the application software 6 will always find a unified ecosystem and unified operating environment in the virtual environments 4 and 5 of the respective computer systems 2 and 3, having the same configuration and/or interfaces to additional components of the respective computer systems 2 and 3, for example. This way, from a perspective of the application software 6, it does not matter in which environment 4 or 5 the respective computer systems 2 and 3 it will be executed, even if the computer systems 2 and 3 have completely different configurations, for example, hardware environments. For example, the virtual environments 4 and 5 each provide unified virtual interfaces that connect the application software 6, respectively. The virtual environments 4 and 5 may here provide unified functionalities for the application software 6 or may also differ in the respective functional scope thereof. The important point is that the application software 6 may be provided and operated directly within the virtual environments 4 and 5 of the associated computer systems 2 and 3 without any further adaptions or version changes.

A respective communication between the application software 6 and additional software and/or hardware within the computer system 2 and 3 is performed by the virtual environments 4 and 5 or the hypervisor 10 and 11 in a controlled way. This way, the application software 6 becomes able to access different hardware interfaces (for example, network cards) of the respective computer systems 2 and 3 by a virtual interface of the respective virtual environments 4 and 5, wherein the application software 6 only connects to the unifiedly configured virtual interface within the virtual environments 4 or 5 and no adaption hereto has to be made because of modifications or differences between the respective computer systems 2 and 3.

Thus, the application software 6 may be transferred from the virtual environment 4 of the edge computer system 2 to the virtual environment 5 of the cloud computer system 3 in a straightforward way. In this regard, the application software 6 is a portable application software.

The computer system infrastructure described here and the method of hosting an application software in a computer system infrastructure described here enable an easy transfer of an application software within the computer system infrastructure between computer systems that may be configured in a completely different way and may be implemented using different features. By configuring the respective virtual environments within the associated computer systems, the application software may be embedded as container file(s) within the virtual environments of the respective computer systems and may be operated therein, wherein the virtual environments perform a communication to the higher-level software and hardware components of the associated computer systems, respectively (controlled by a hypervisor, if appropriate). This way, the application software may be moved between different computer systems as required. Thus, a service between the edge and the cloud may be ported in a flexible way in both directions. The transfer of application software between the associated computer systems is advantageously performed by using determined resource information that is evaluated regarding a determined resource event that triggers the transfer depending on the situation. The control of such a transfer may be performed by resource control components by using higher-level resource decision logics, if appropriate, by predetermined metrics. No dedicated management systems are required to control a transfer between the executing computer systems within the computer system infrastructure. The configuration shown is chosen as being only exemplary.

1. A computer system infrastructure comprising at least one edge computer system and at least one cloud computer system, wherein
the edge computer system is connectable to the cloud computer system,
both in the edge computer system and in the cloud computer system a virtual environment for hosting an application software is configured, respectively, the virtual environment of the edge computer system and the virtual environment of the cloud computer system are configured as unified host environments for the application software, respectively,
the application software is provided within one of the virtual environments of the edge computer system and the cloud computer system, and
the edge computer system and the cloud computer system are configured to transfer the application software between the two virtual environments of the edge computer system and the cloud computer system.

2. The computer system infrastructure according to claim 1, wherein, in the edge computer system, a first resource control component is configured to determine resource information of the edge computer system, and in the cloud computer system a second resource control component is configured to determine resource information of the cloud computer system, and
the edge computer system and the cloud computer system are configured to transfer the application software depending on the resource information determined by the first and/or the second resource control component between the edge computer system and the cloud computer system.

3. The computer system infrastructure according to claim 2, wherein, in the edge computer system and/or in the cloud computer system, a resource decision logic is implemented to decide whether a transfer of the application software between the edge computer system and the cloud computer system has to be performed depending on the resource information determined by the first and/or second resource control component.

4. The computer system infrastructure according to claim 2, wherein the first resource control component and the second resource control component are configured to communicate with each other and exchange determined resource information.

5. The computer system infrastructure according to claim 1, wherein the application software is configured as one or more container files.

6. A method of hosting an application software in a computer system infrastructure comprising at least one edge computer system and at least one cloud computer system, comprising at least temporarily connecting the edge computer system to the cloud computer system such that both the edge computer system and the cloud computer system each provide a virtual environment to host an application software, respectively, wherein the virtual environment of the edge computer system and the virtual environment of the cloud computer system are configured as unified host environments for the application software and the application software is provided within one of the virtual environments of the edge computer system and the cloud computer system, and,
when a predetermined resource event occurs, is transferred to the other of the virtual environments of the edge computer system and the cloud computer system.

7. The method according to claim 6, wherein in the edge computer system resource information of the edge computer system is determined, and in the cloud computer system resource information of the cloud computer system is determined, and wherein the determined resource information is evaluated regarding the occurrence of the predetermined resource event.

8. The method according to claim 7, wherein the edge computer system and the cloud computer system exchange determined resource information

9. The method according to claim 6, wherein the application software is provided as one or more container files.

10. The method according to claim 7, wherein the application software is provided as one or more container files.

11. The method according to claim 8, wherein the application software is provided as one or more container files.

12. The computer system infrastructure according to claim 3, wherein the first resource control component and the second resource control component are configured to communicate with each other and exchange determined resource information.

13. The computer system infrastructure according to claim 2, wherein the application software is configured as one or more container files.

14. The computer system infrastructure according to claim 3, wherein the application software is configured as one or more container files.

15. The computer system infrastructure according to claim 4, wherein the application software is configured as one or more container files.
